(19) United States
(12) Patent Application Publication
(10) Pub. No.: US 2017/0094579 A1
(43) Pub. Date: Mar. 30, 2017

(54) SENSOR NETWORK SYSTEM, DATA TRANSMISSION METHOD AND SENSOR NODE USED IN SENSOR NETWORK SYSTEM

(71) Applicant: FUJITSU LIMITED, Kawasaki-shi (JP)

(72) Inventors: Koji Kurihara, Kawasaki (JP); Koichiro Yamashita, Hachioji (JP); Takahisa Suzuki, Yokohama (JP); Toshiya Otomo, Kawasaki (JP)

(73) Assignee: FUJITSU LIMITED, Kawasaki-shi (JP)

(21) Appl. No.: 15/377,536

(22) Filed: Dec. 13, 2016

Related U.S. Application Data
(63) Continuation of application No. PCT/JP2014/065946, filed on Jun. 16, 2014.

(51) Int. Cl. H04W 40/10; H04W 48/10; H04W 52/02

(52) U.S. Cl. CPC H04W 40/10; H04W 52/0261; H04W 48/10; H04W 84/18

(57) ABSTRACT

A sensor network system includes: a plurality of sensor nodes; and a server configured to collect data from the plurality of sensor nodes. When a first sensor node among the plurality of sensor nodes obtains data, the first sensor node selects a first transmission mode to directly transmit the data to the server or a second transmission mode to transmit the data to another sensor node among the plurality of sensor nodes based on a first energy to directly transmit the data to the server, a second energy to transmit the data to the other sensor node, and a third energy to store the data in the first sensor node, and the first sensor node transmits the data to the server or the other sensor node in the selected transmission mode.

### CROSS-REFERENCE TO RELATED APPLICATION

This application is a continuation application of International Application PCT/JP2014/065946 filed on Jun. 16, 2014 and designated the U.S., the entire contents of which are incorporated herein by reference.

### FIELD

The embodiments discussed herein are related to a sensor network system, a data transmission method used in the sensor network system, and a sensor node used in the sensor network system.

### BACKGROUND

A sensor network system includes a large number of sensor nodes in a sensing target area, and collects data by using the sensor nodes. Each of the sensor nodes includes one or more sensors, and obtains sensing data. As an example, in a system that investigates the water quality of the sea, each of the sensor nodes includes a sensor that detects water quality, and generates data indicating the detected water quality. In a system that monitors a landslide, each of the sensor nodes includes a sensor that detects ground strain, and generates data indicating the detected strain. Each of the sensor nodes transmits the obtained sensing data to a server.

In recent years, a sensor network system in which respective sensor nodes are movable has been put into practical use. As an example, in the field of intelligent transport systems (ITS), a sensor node is installed onto each vehicle (and each person). In this case, the sensor node transmits sensing data to a server by using radio communication.

A system that enables a current position of a sea bather to be reported to a monitoring center has been proposed (for example, Japanese Laid-open Patent Publication No. 2005-348011). In addition, a sensor information collection method in which power saving is achieved and communication reliability is enhanced has been proposed (for example, Japanese Laid-open Patent Publication No. 2010-193413). Further, a data transmission method that enables data collected in respective sensor nodes to be surely transmitted to a sink node has been proposed (for example, Japanese Laid-open Patent Publication No. 2006-287565).

In the sensor network system in which sensor nodes are movable, the respective sensor nodes often directly transmit data to a server. In this case, the respective sensor nodes transmit data with a transmission power at which a radio signal can reach the server. This results in an increase in power consumption in the respective sensor nodes.

Here, it is assumed, for example, that each of the sensor nodes operates by using a battery implemented in the sensor node. In this case, when a power consumption to transmit data is large, the life of the battery becomes short. Namely, a period during which the sensor node can operate becomes short. In the sensor network system, when the number of available sensor nodes decreases, the value of collected information also decreases.

### SUMMARY

According to an aspect of the present invention, a sensor network system includes: a plurality of sensor nodes; and a server configured to collect data from the plurality of sensor nodes. When a first sensor node among the plurality of sensor nodes obtains data, the first sensor node selects a first transmission mode to directly transmit the data to the server or a second transmission mode to transmit the data to another sensor node among the plurality of sensor nodes based on a first energy to directly transmit the data to the server, a second energy to transmit the data to the other sensor node, and a third energy to store the data in the first sensor node, and the first sensor node transmits the data to the server or the other sensor node in the selected transmission mode.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a sensor network system according to an embodiment.

FIG. 2 illustrates an example of the hardware configuration of a sensor node.

FIG. 3 illustrates examples of functions that are provided by a processor of a sensor node.

FIG. 4A illustrates an example of the format of transmission data.

FIG. 4B illustrates an example of the format of a beacon signal.

FIG. 5 is a diagram explaining an average battery residual capacity and a standard deviation.

FIGS. 6-12 illustrate an example of transmission of data from a sensor node to a data collection server.

FIG. 13 is a flowchart illustrating the operation of a sensor node.

FIG. 14 is a flowchart illustrating a beacon response process.

FIG. 15 is a flowchart illustrating data circulation evaluation.

FIG. 16 is a flowchart illustrating real-time property evaluation.

FIG. 17 is a flowchart illustrating battery residual capacity evaluation.

FIG. 18 is a flowchart illustrating a multi-hop communication process.

FIG. 19 is a flowchart illustrating a transmission power updating process.

### DESCRIPTION OF EMBODIMENTS

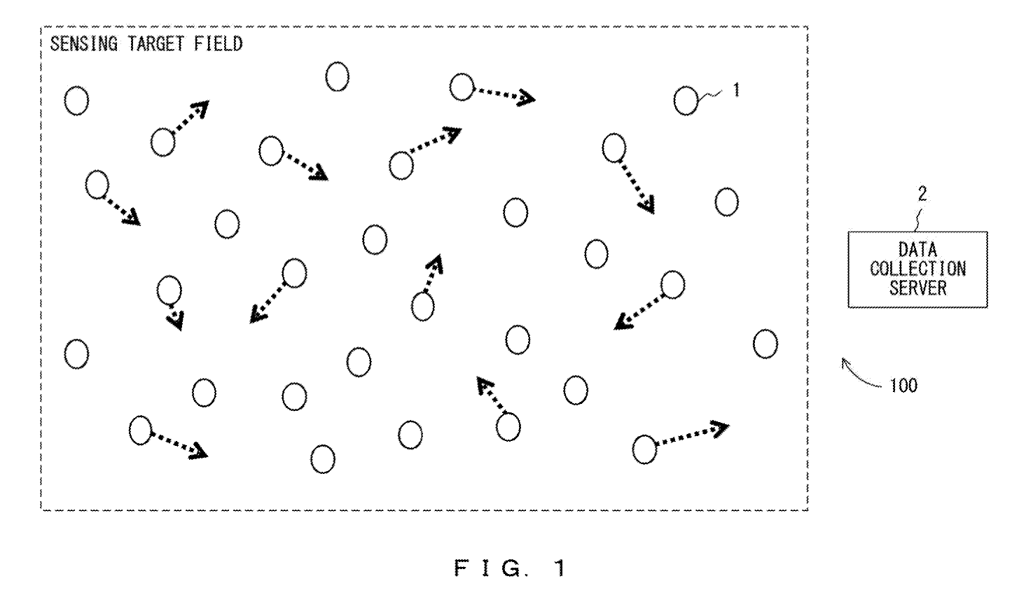

FIG. 1 illustrates an example of a sensor network system according to an embodiment of the invention. In the example illustrated in FIG. 1, a sensor network system 100 includes a plurality of sensor nodes 1 and a data collection server 2 that collects data from the plurality of sensor nodes 1. In FIG. 1, each of the sensor nodes 1 is expressed by an oval symbol.

The sensor node 1 is a sensor device that includes one or more sensors. In addition, the sensor node 1 can transmit and receive a signal via a radio link. Namely, the sensor node 1 can process data, can sense a surrounding environment, and can communicate with another sensor node and a server in a wireless network.

The sensor network system 100 is configured by arranging (or distributing) a large number of sensor nodes 1 in a sensing target field. In this example, the sensing target field refers to an area in which environmental data is to be collected. It is assumed that the respective sensor nodes 1 are movable. As an example, in a case in which the sensor node 1 is installed onto a vehicle, the position of the sensor node 1 changes when the vehicle travels. In a case in which the sensor node 1 is distributed in the sea, the position of the sensor node 1 may change due to waves and the tide. Dashed arrows illustrated in FIG. 1 express a state in which the sensor nodes 1 are moving.

The sensor node 1 can sense environment by using a sensor. When the environment is sensed by the sensor, the sensor node 1 generates environmental data indicating a sensing result. As an example, when the sensor node 1 includes a temperature sensor, the sensor node 1 generates temperature data. When the sensor node 1 generates the environmental data, the sensor node 1 transmits the environmental data to the data collection server 2. Note that the sensor node 1 can use the two transmission modes below.

(1) Multi-hop communication mode
(2) Direct communication mode

When the sensor node 1 selects the multi-hop communication mode, the sensor node 1 transmits the generated environmental data to another sensor node. In this case, the sensor node that receives the environmental data selects the multi-hop communication mode or the direct communication mode, and transmits the environmental data in the selected transmission mode. When the sensor node 1 selects the direct communication mode, the sensor node 1 directly transmits the obtained environmental data to the data collection server 2.

At this time, the sensor node 1 can select a transmission mode considering various factors. In this example, the sensor node 1 selects a transmission mode according to the following factors.

(1) Energy consumption evaluation (to reduce the power consumption of the sensor node 1)
(2) Real-time property evaluation (to forward environmental data to the data collection server 2 within a specified time period)
(3) Battery residual capacity evaluation (to reduce variation in a battery residual capacity of a plurality of sensor nodes 1 in a sensing target field)
(4) Data circulation evaluation (to prevent a state in which environmental data is circulated in a sensing target field in multi-hop communication)

In this application, it is assumed that “energy” is expressed, for example, by “electric power”. Here, an electric power needed for the sensor node 1 to transmit environmental data depends on a propagation distance of a radio signal. Accordingly, as an example, in order to reduce power consumption of each of the sensor nodes 1, it is preferable that the multi-hop communication mode, not the direct communication mode, be selected. However, in order to satisfy requests relating to the other factors (2) to (4), the sensor node 1 may transmit environmental data in the direct communication mode. A method in which the respective sensor node 1 selects a transmission mode will be described later in detail.

As described above, the respective sensor nodes 1 transmit environmental data to the data collection server 2 in the direct communication mode or the multi-hop communication mode. Consequently, the data collection server 2 can collect the environmental data that the respective sensor nodes 1 sensed. The data collection server 2 analyzes, for example, the environment of the sensing target field, in accordance with the collected environmental data.

In the description above, the sensor network system 100 includes the plurality of sensor nodes 1 and the data collection server 2; however, the invention is not limited to this configuration. As an example, the data collection server 2 may be omitted from the sensor network system 100. Namely, a network that is configured by a plurality of sensor nodes 1 may be referred to as a “sensor network system”.

The sensor node 1 can generate environmental data from a sensing result of a sensor in the sensor node itself. The sensor node 1 may receive environmental data from another node. In the description below, it is assumed that an operation for the sensor node 1 to obtain environmental data includes an operation to generate environmental data from a sensing result of a sensor in the sensor node itself and an operation to receive environmental data from another node.

In the description above, the sensor node 1 obtains environmental data; however, the invention is not limited to this configuration. Namely, the sensor node 1 may obtain data other than environmental data. Accordingly, in the description below, various pieces of data that are transmitted from the sensor node 1 to the data collection server 2 may be simply referred to as “data”.

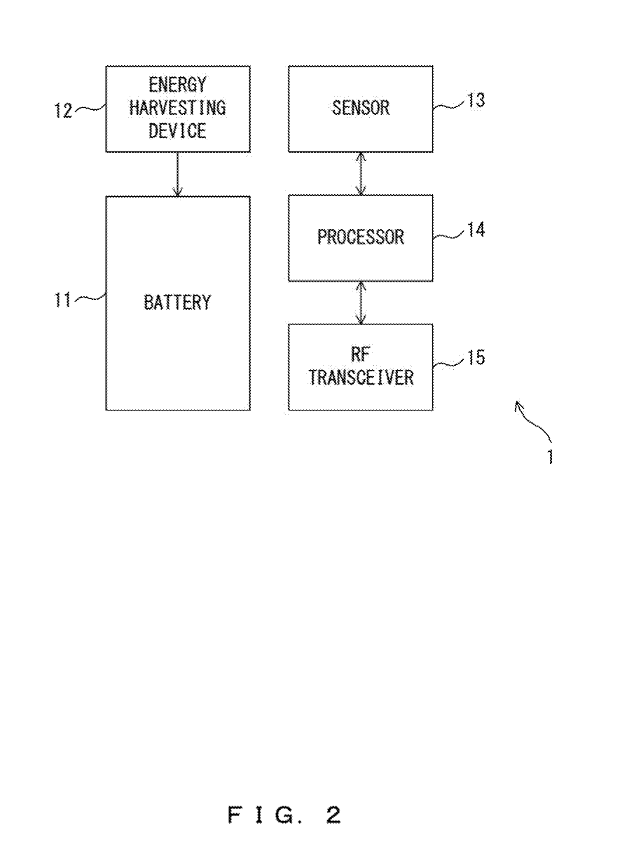

FIG. 2 illustrates an example of the hardware configuration of the sensor node 1. The sensor node 1 includes a battery 11, an energy harvesting device 12, a sensor 13, a processor 14, and an RF transceiver 15, as illustrated in FIG. 2.

The battery 11 stores electric energy. The battery 11 supplies electric power to the sensor 13, the processor 14, and the RF transceiver 15. The energy harvesting device 12 can generate electric energy by using radio waves, light, temperature, vibrations, or the like. The electric energy generated by the energy harvesting device 12 is stored in the battery 11.

The sensor 13 senses a state or environment that corresponds to the type of the sensor. As an example, when the sensor 13 is a temperature sensor, the sensor 13 detects temperature around the sensor node 1. The processor 14 selects a transmission mode when the sensor node 1 obtains data. The phrase “when the sensor node 1 obtains data” includes “when data is generated from a sensing result of the sensor 13” and “when data is received from another sensor node 1”. It is also assumed that the processor 14 includes a memory and a clock.

The RF transceiver 15 transmits the data obtained by the sensor node 1 in a transmission mode selected by the processor 14. Namely, when the multi-hop communication mode is selected, the RF transceiver 15 transmits data to a sensor node 1 that is specified by using the beacon described later. When the direct communication mode is selected, the RF transceiver 15 directly transmits data to the data collection server 2. In addition, the RF transceiver 15 can receive a radio signal from another sensor node 1 and the data collection server 2. In the RF transceiver 15, a circuit to transmit and receive a radio signal to/from another sensor node 1 and a circuit to transmit and receive a radio signal to/from the data collection server 2 may be independent of each other.

In the sensor node 1, the processor 14 may be configured to be started as needed. In this case, as an example, the sensor 13 may start the processor 14 when a newly sensed value is different from a previously sensed value. The sensor 13 may be configured to output a sensing result to the processor 14 when the sensor 13 has received a sensing instruction. The sensing instruction is given, for example, from the data collection server 2 to the sensor node 1. Alternatively, the processor 14 may generate the sensing instruction.

The energy harvesting device 12 may be omitted from the sensor node 1. In this case, when the battery 11 runs out, the sensor node 1 does not operate. However, when the battery 11 is replaced, the sensor node 1 can continue to operate. The sensor node 1 may include another circuit element that is not illustrated in FIG. 2.

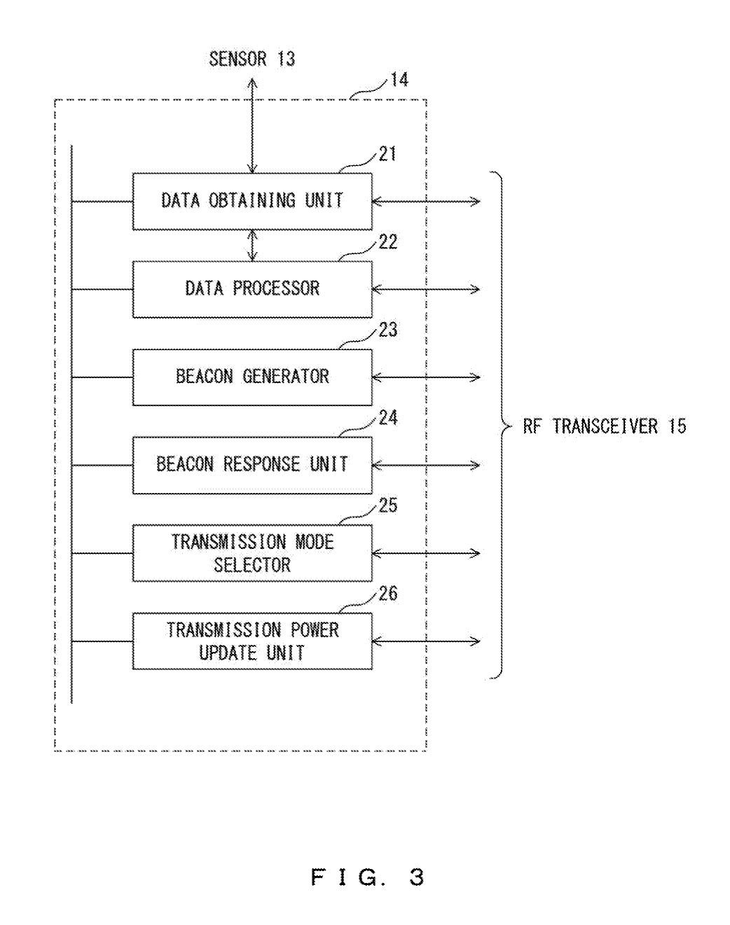

FIG. 3 illustrates functions that are provided by the processor 14 of the sensor node 1. The processor 14 can provide a data obtaining unit 21, a data processor 22, a beacon generator 23, a beacon response unit 24, a transmission mode selector 25, and a transmission power update unit 26 by executing a given program. Some of these functions may be implemented by a hardware circuit. The processor 14 can also provide other functions that are not illustrated in FIG. 3.

The data obtaining unit 21 obtains data indicating a sensing result of the sensor 13. In addition, the data obtaining unit 21 obtains data that the RF transceiver 15 receives from another sensor node 1. The data processor 22 generates transmission data from the data obtained by the data obtaining unit 21.

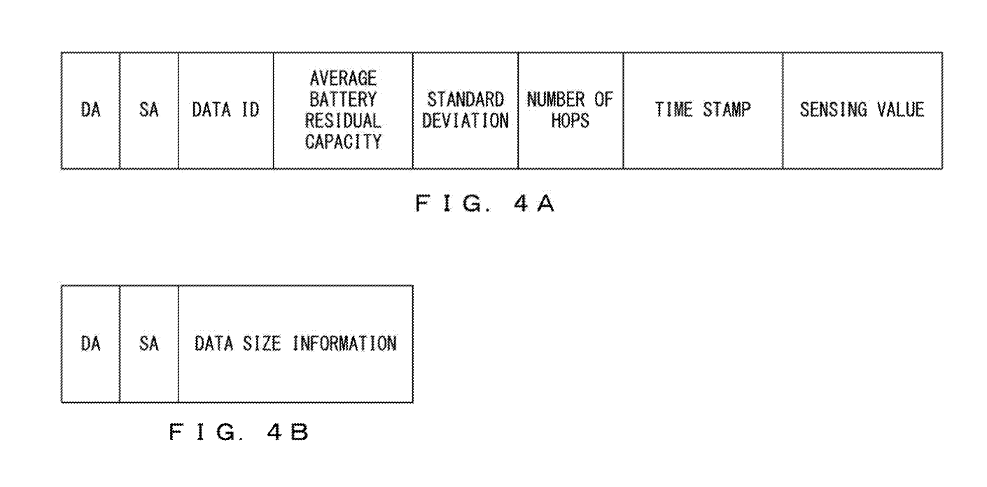

FIG. 4A illustrates an example of the format of transmission data. In this example, the transmission data includes a destination address (DA), a source address (SA), a data ID, average battery residual capacity data, a standard deviation, number of hops data, a time stamp, and a sensing value.

The destination address indicates a sensor node 1 that is specified by using the beacon described later, when the multi-hop communication mode is selected. When the direct communication mode is selected, the destination address indicates the data collection server 2. The source address indicates a sensor node (a local node) 1. The data ID identifies each data in the sensor network system 100. The average battery residual capacity indicates an average battery residual capacity of respective sensor nodes 1 on a route from a sensor node 1 that generated data to a local node. The standard deviation indicates a standard deviation of battery residual capacities of the respective sensor nodes 1 on the route from the sensor node 1 that generated data to the local node. The number of hops indicates the number of hops from the sensor node 1 that generated data to the local node. Accordingly, the number of hops corresponds to the number of sensor nodes 1 on the route from the sensor node 1 that generated data to the local node. The time stamp indicates a time at which data was generated. The sensing value indicates a value sensed by the sensor 13.

The transmission data may include other information elements that are not illustrated in FIG. 4A. The sensor node 1 may collectively transmit sensing values that have respectively been sensed by a plurality of sensor nodes to the next node or the data collection server 2. It is assumed, for example, that data is multi-hop-forwarded via sensor nodes A, B, C, . . . . It is also assumed that the sensor nodes A, B, and C respectively generate data A, data B, and data C. In this case, the sensor node A transmits the data A to the sensor node B. The sensor node B collectively transmits the data B and the received data A to the sensor node C. The sensor node C collectively transmits the data C and the received data A and data B to the next node. In this case, the number of times of data transmission decreases, and therefore power consumption of each of the sensor nodes 1 and/or power consumption of the entirety of the sensor network system 100 decrease, and a load of data reception processing on the data collection server 2 decreases.

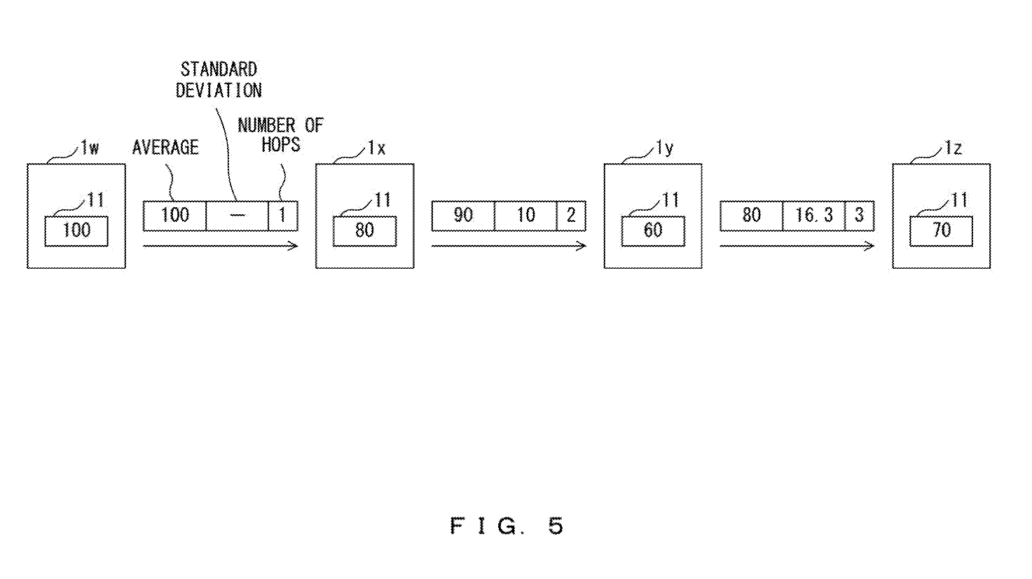

FIG. 5 is a diagram explaining the average battery residual capacity and the standard deviation. In this example, it is assumed that data generated by a sensor node 1w is transmitted to a sensor node 1z via sensor nodes 1x and 1y. Values “100”, “80”, “60”, and “70” expressed for the sensor nodes 1w, 1x, 1y, and 1z respectively indicate residual capacities of the batteries 11.

The residual capacity of the battery 11 of the sensor node 1w is “100”. Accordingly, an average battery residual capacity and a standard deviation that are reported from the sensor node 1w to the sensor node 1x are described below.

Average battery residual capacity: 100 (a battery residual capacity of the sensor node 1w)
Standard deviation: absent

The residual capacity of the battery 11 of the sensor node 1x is “80”. Accordingly, an average battery residual capacity and a standard deviation that are reported from the sensor node 1x to the sensor node 1y are described below.

Average battery residual capacity: 90 (an average battery residual capacity of the sensor nodes 1w and 1y)
Standard deviation: 10 (a standard deviation of the battery residual capacities of the sensor nodes 1w and 1x)

The residual capacity of the battery 11 of the sensor node 1y is “60”. Accordingly, an average battery residual capacity and a standard deviation that are reported from the sensor node 1y to the sensor node 1z are described below.

Average battery residual capacity: 80 (an average battery residual capacity of the sensor nodes 1w, 1x, and 1y)
Standard deviation: 16.3 (a standard deviation of the battery residual capacities of the sensor nodes 1w, 1x, and 1y)

The average battery residual capacity and the standard deviation are used when a sensor node 1 that has received data selects a transmission mode. As an example, the sensor node 1z illustrated in FIG. 5 may select the multi-hop communication mode or the direct communication mode in accordance with an average battery residual capacity and a standard deviation that have been reported from the sensor node 1y and the battery residual capacity of the sensor node 1z. An example of a method for selecting a transmission mode by using the average battery residual capacity and the standard deviation (namely, battery residual capacity evaluation) will be descried later.

The beacon generator 23 generates a beacon signal. The beacon signal includes a destination address (DA), a source address (SA), and data size information, as illustrated in FIG. 4B. The beacon signal is used to search for a destination node of the data illustrated in FIG. 4A, and therefore a multicast address is specified, for example, for the destination address. The source address indicates a sensor node (a local node) 1. The data size information indicates the size of the data illustrated in FIG. 4A.

The beacon response unit 24 generates a beacon response when the sensor node 1 receives a beacon signal. In this example, the beacon response unit 24 generates the beacon response when data that corresponds to the received beacon signal can be transmitted to the data collection server 2.

The transmission mode selector 25 selects a transmission mode (the multi-hop communication mode or the direct communication mode) for transmitting data generated by the data processor 22. The transmission power update unit 26 determines a transmission power to transmit a beacon signal. In this example, a transmission power to transmit data in the multi-hop communication mode is the same as a transmission power to transmit a beacon signal. Processing performed by the transmission mode selector 25 and the transmission power update unit 26 will be described later in detail.

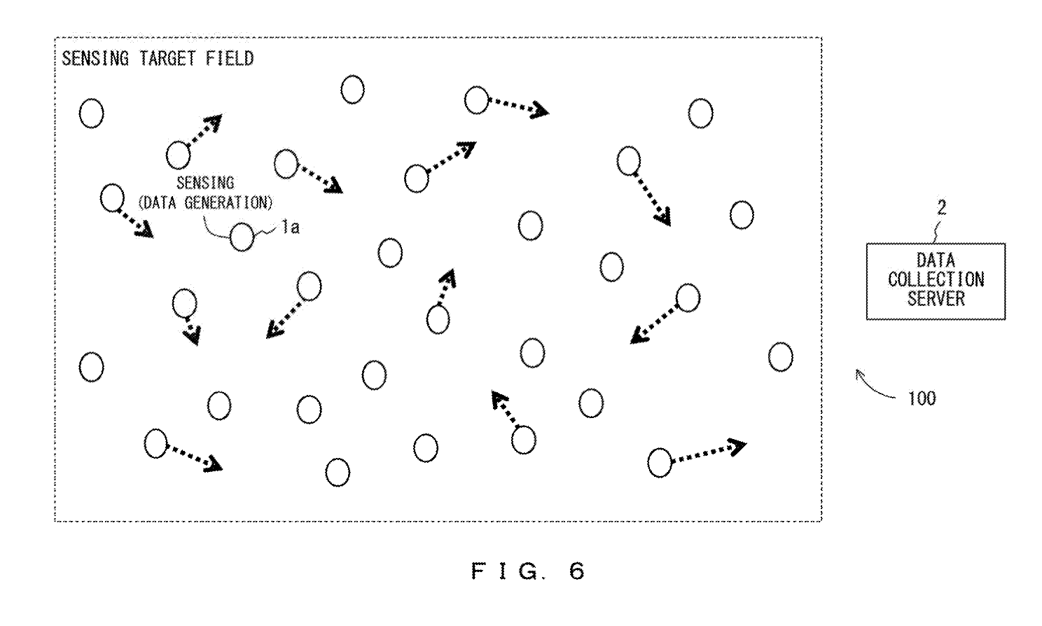

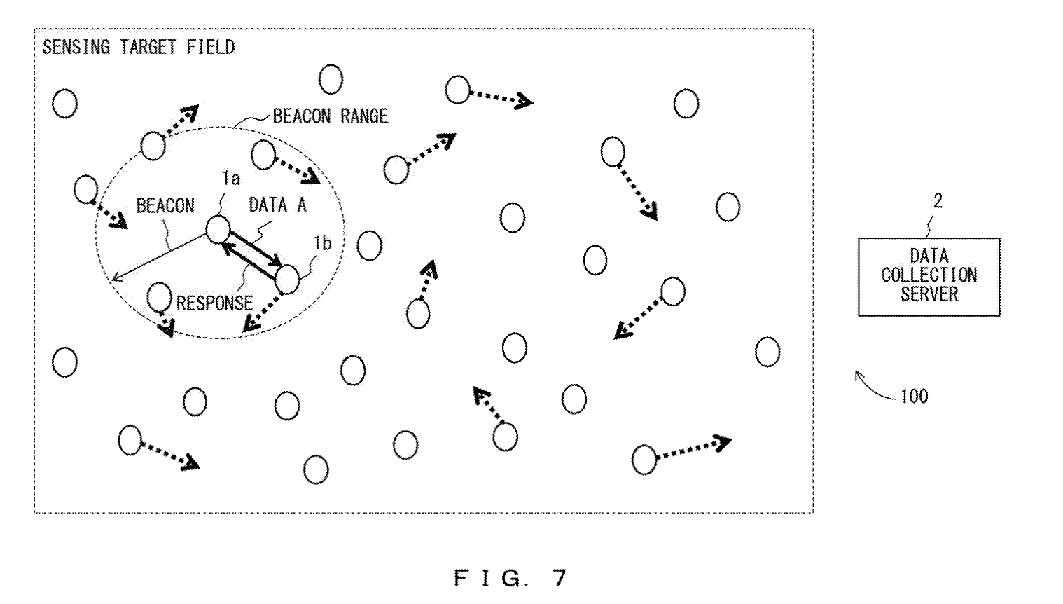

An example of data transmission from the sensor node 1 to the data collection server 2 is described with reference to FIGS. 6-12. In this example, data that indicates a value that was sensed by a sensor node 1a illustrated in FIG. 6 (hereinafter referred to as data A) is transmitted to the data collection server 2. Arrows that are added to some sensor nodes 1 in FIG. 6 indicate the movement of the sensor nodes. Arrows in FIGS. 7-12 have the same meaning as the meaning of the arrows in FIG. 6.

The sensor node 1a transmits a beacon signal, as illustrated in FIG. 7. At this time, the sensor node 1a transmits the beacon signal at a transmission power that has been specified by the transmission power update unit 26. The beacon signal is received by a sensor node 1 that is located within a range that corresponds to the transmission power. In the description below, a range in which a beacon signal reaches may be referred to as a “beacon range”.

The beacon signal includes the data size information, as illustrated in FIG. 4B. In the case illustrated in FIG. 7, the beacon signal transmitted from the sensor node 1a includes data size information indicating the size of the data A. The sensor node 1 that has received the beacon signal determines according to the data size information whether the data A can be transmitted to the data collection server 2 in the direct communication mode.

The sensor node 1 that has received the beacon signal of the sensor node 1a returns a beacon response when the data A can be transmitted to the data collection server 2 in the direct communication mode. In the example illustrated in FIG. 7, a beacon response is returned from a sensor node 1b to the sensor node 1a.

Upon receipt of the beacon response from the sensor node 1b, the sensor node 1a selects a transmission mode to transmit the data A to the data collection server 2. In this example, it is assumed that the multi-hop communication mode is selected for a transmission mode. In this case, the sensor node 1a transmits the data A to a source node of the beacon response (namely, the sensor node 1b). Consequently, the data A that indicates a value sensed by the sensor node 1a is received by the sensor node 1b.

Upon receipt of beacon responses from a plurality of nodes, the sensor node 1a transmits the data A, for example, to a node that first returned the beacon response. When the sensor node 1a fails to receive a beacon response within a specified time period, the sensor node 1a gives up multi-hop forwarding, and transmits the data A to the data collection server 2 in the direct communication mode.

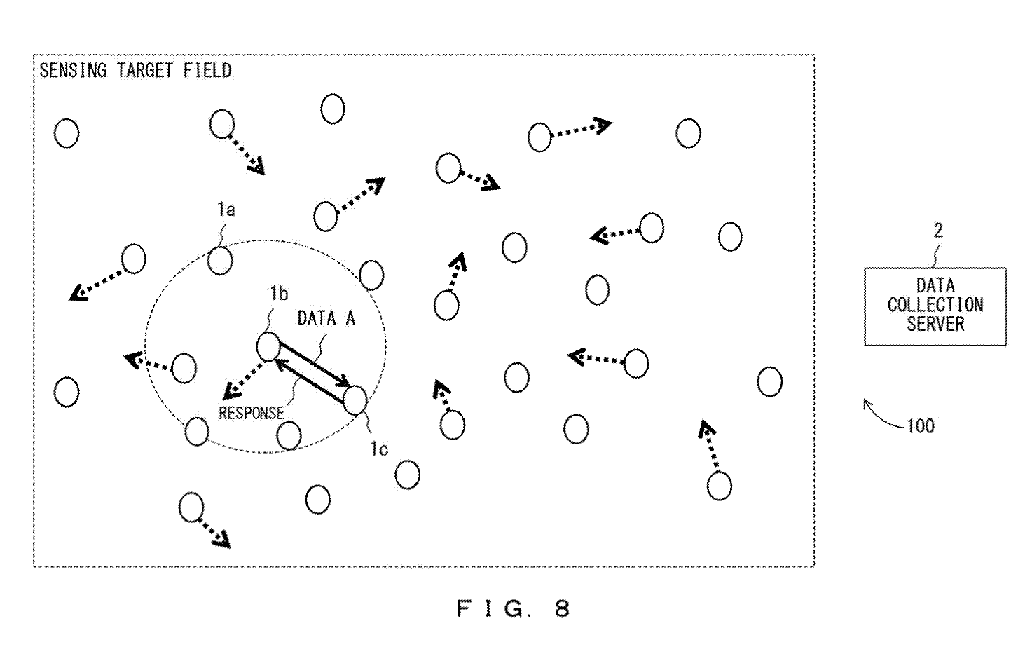

FIGS. 8-11 illustrate a multi-hop forwarding that is similar to that in FIG. 7. Namely, in FIGS. 8-11, the data A is sequentially forwarded in the multi-hop communication. Details are described below.

In FIG. 8, the sensor node 1b transmits a beacon signal, and a sensor node 1c returns a beacon response that corresponds to the beacon signal. The sensor node 1b selects a transmission mode for transmitting the data A to the data collection server 2. In this example, the multi-hop communication mode is selected. In this case, the sensor node 1b transmits the data A to a source node of the beacon response (namely, the sensor node 1c). Consequently, the data A that indicates a value sensed by the sensor node 1a is forwarded to the sensor node 1c.

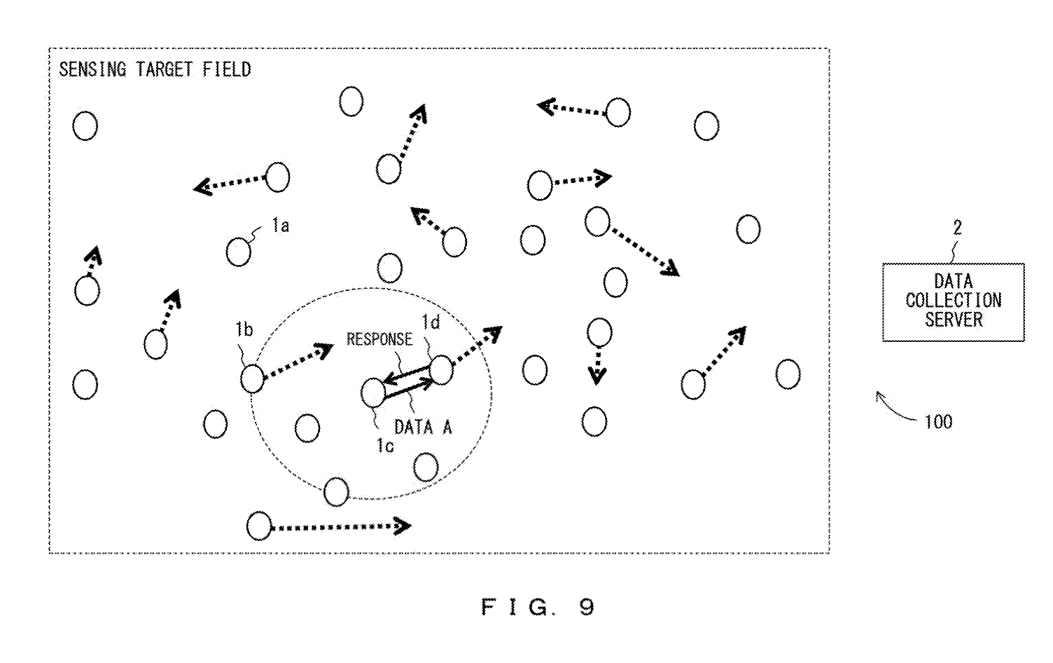

In FIG. 9, the sensor node 1c transmits a beacon signal, and a sensor node 1d returns a beacon response that corresponds to the beacon signal. The sensor node 1c also selects a transmission mode for transmitting the data A to the data collection server 2. In this example, the multi-hop communication mode is selected. In this case, the sensor node 1c transmits the data A to a source node of the beacon response (namely, the sensor node 1d). Consequently, the data A that indicates a value sensed by the sensor node 1a is forwarded to the sensor node 1d.

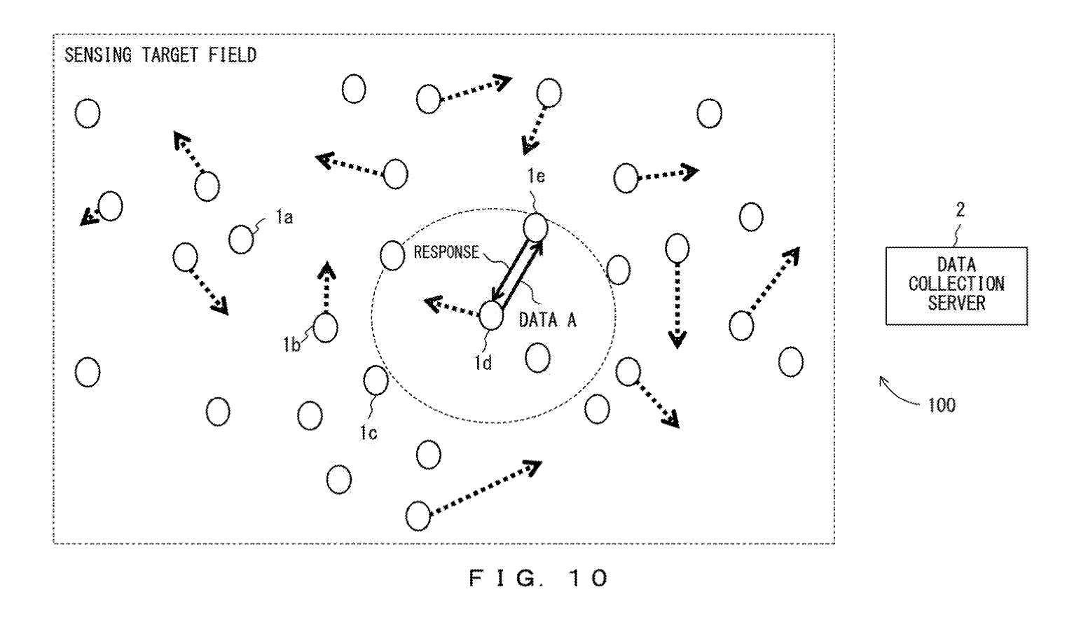

In FIG. 10, the sensor node 1d transmits a beacon signal, and a sensor node 1e returns a beacon response that corresponds to the beacon signal. The sensor node 1d also selects a transmission mode for transmitting the data A to the data collection server 2. In this example, the multi-hop communication mode is selected. In this case, the sensor node 1d transmits the data A to a source node of the beacon response (that is, the sensor node 1e). Consequently, the data A that indicates a value sensed by the sensor node 1a is forwarded to the sensor node 1e.

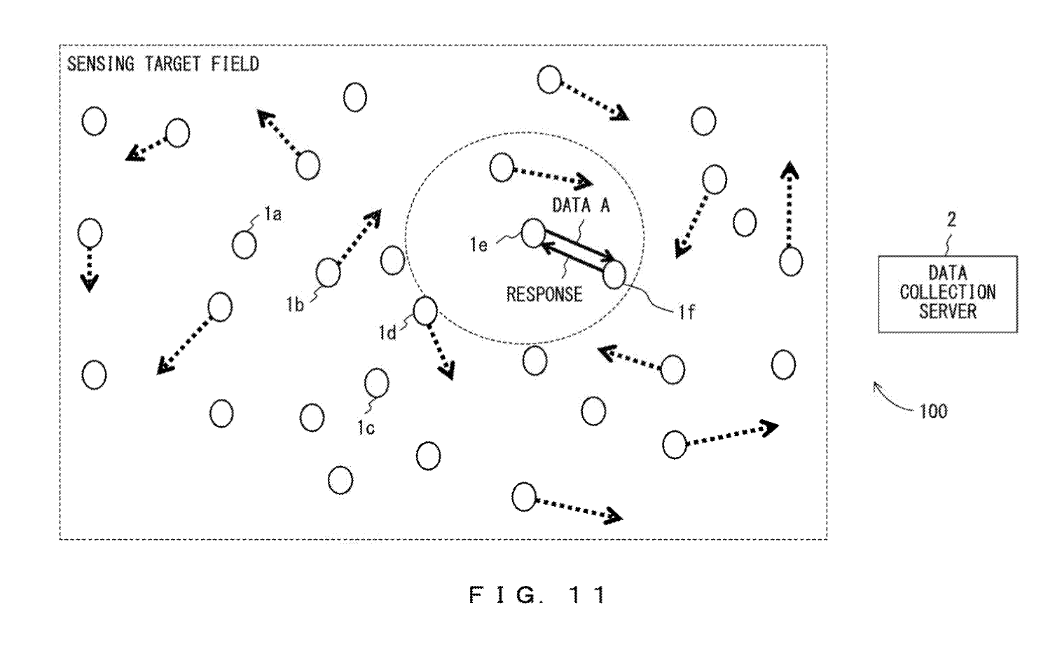

In FIG. 11, the sensor node 1e transmits a beacon signal, and a sensor node 1f returns a beacon response that corresponds to the beacon signal. The sensor node 1e also selects a transmission mode for transmitting the data A to the data collection server 2. In this example, the multi-hop communication mode is selected. In this case, the sensor node 1e transmits the data A to a source node of the beacon response (namely, the sensor node 1f). Consequently, the data A that indicates a value sensed by the sensor node 1a is forwarded to the sensor node 1f.

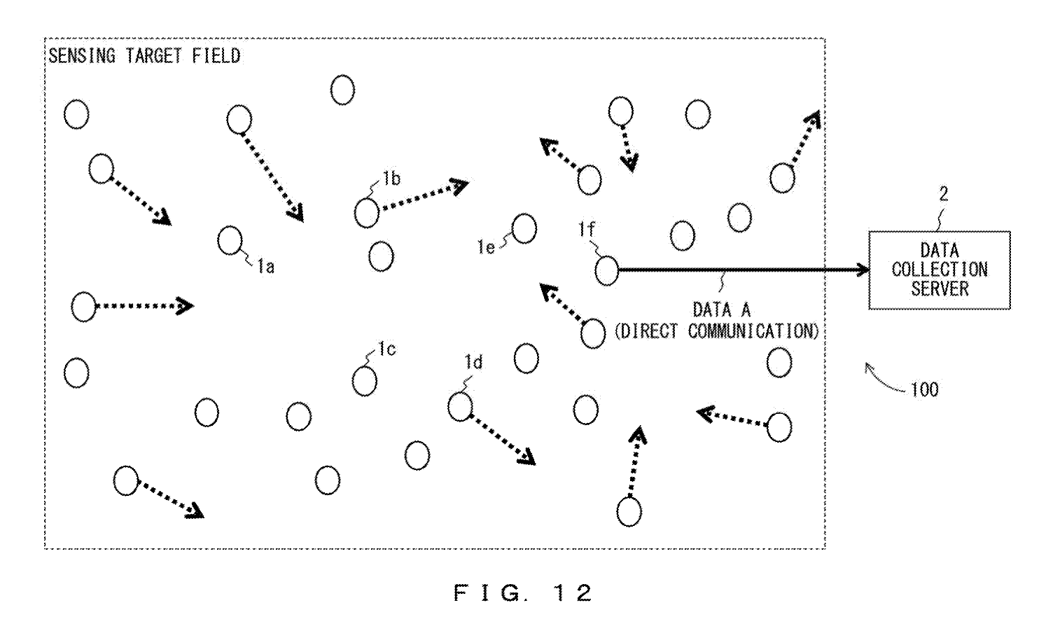

The sensor node 1f selects a transmission mode for transmitting the data A to the data collection server 2, similarly to the sensor nodes 1a-1e. In this example, the sensor node 1f selects the direct communication mode. Then, the sensor node 1f directly transmits the data A to the data collection server 2, as illustrated in FIG. 12. At this time, the destination address of the data A is the data collection server 2. The sensor node 1f transmits the data A to the data collection server 2 at a transmission power that has been specified in advance for the direct communication mode.

In the transmission data illustrated in FIG. 4A, “average battery residual capacity”, “standard deviation”, and “number of hops” are used to perform battery residual capacity evaluation in the sensor node 1. Accordingly, the sensor node 1f may delete “average battery residual capacity”, “standard deviation”, and “number of hops” from transmission data transmitted to the data collection server 2 when sensor node 1f transmits the data A in the direct communication mode.

In the example illustrated in FIGS. 6-12, when one or more of the following states are detected, the sensor node 1f selects the direct communication mode.

(1) The sum of “energy En to transmit data A to an adjacent node” and “energy Eh to store data A in the sensor node 1f” is greater than or equal to “energy Es to directly transmit data A to the data collection server 2”.
(2) A time period that has passed after a measurement time of data A (a time at which data A was generated in the sensor node 1a) is greater than or equal to a specified threshold time period.
(3) A battery residual capacity of the sensor node 1f is greater than or equal to a reference batter residual capacity that is determined according to the average and the standard deviation of the battery residual capacities of the sensor node 1a-1e. The reference battery residual capacity is calculated, for example, according to Cₐᵥₑ+2C_{dev}. Cₐᵥₑ indicates the reported average battery residual capacity. C_{dev} indicates the reported standard deviation. The reference battery residual capacity may be calculated by using another method.

The above states (1) to (3) respectively correspond to energy consumption evaluation, real-time property evaluation, and battery residual capacity evaluation. The sensor node 1f may also perform data circulation evaluation. However, in the example illustrated in FIGS. 6-12, the data A has not been processed by the sensor node 1f, and therefore the direct communication mode is not selected based on data circulation evaluation.

As described above, the sensor node 1 that obtains data selects a transmission mode for transmitting the data to the data collection server 2. At this time, the sensor node 1 transmits the data in the multi-hop communication mode, unless the direct communication mode is selected based on energy consumption evaluation, real-time property evaluation, battery residual capacity evaluation, or data circulation evaluation. A transmission power (namely, energy consumption) in the multi-hop communication mode is smaller than that in the direct communication mode. Accordingly, power consumption of each of the sensor nodes 1 can be reduced in the sensor network system 100. Consequently, the number of sensor nodes 1 that stop operating due to running-out of a battery is reduced.

By performing real-time property evaluation, the data collection server 2 can collect data that has been generated by each of the sensor nodes 1 without delay. By performing data circulation evaluation, the data collection server 2 can surely collect data that has been generated by each of the sensor nodes 1.

Further, by performing battery residual capacity evaluation, the direct communication mode is likely to be performed in a sensor node 1 that has a greater battery residual capacity than that of another sensor node. Therefore, variation in a battery residual capacity of a plurality of sensor nodes 1 in the sensor network system 100 is suppressed. Namely, also by introducing battery residual capacity evaluation, the number of sensor nodes 1 that stop operating due to running-out of a battery is reduced.

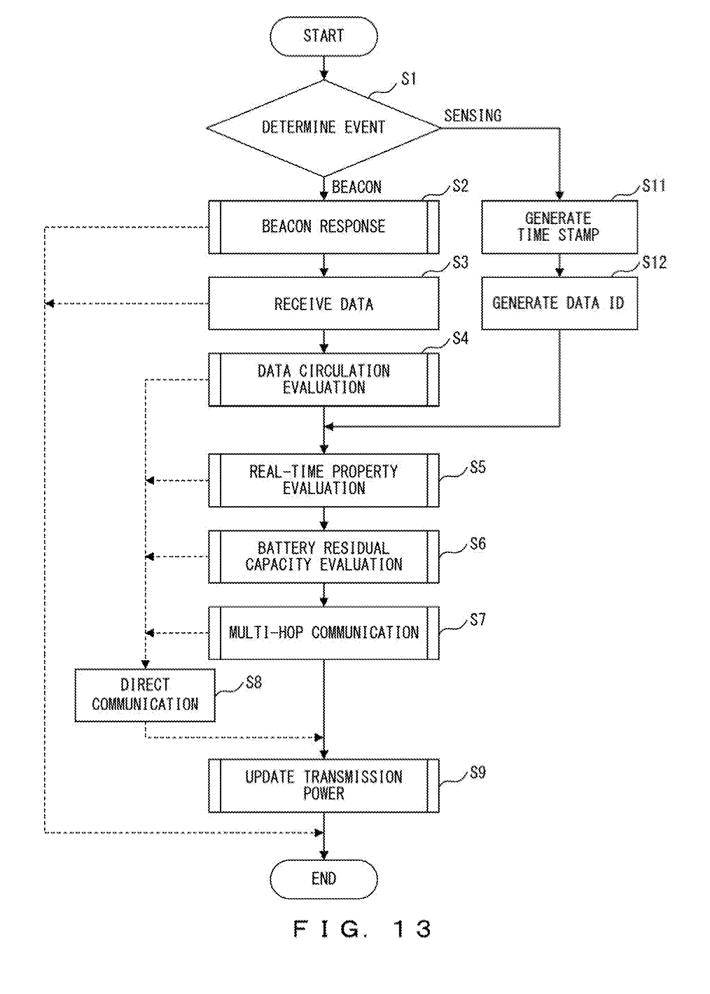

FIG. 13 is a flowchart illustrating the operation of the sensor node 1. Processing of this flowchart is performed by the processor 14. In this example, it is assumed that, when a specified event occurs, the processor 14 is started and performs processing of the flowchart illustrated in FIG. 13. Specifically, when a sensing result is given from the sensor 13 to the processor 14, or when the sensor node 1 receives a beacon signal from another sensor node, the processor 14 is started. Accordingly, processing after the event above has occurred is describe below.

In S1, the processor 14 determines whether an event that has occurred is sensing or reception of a beacon signal. When the sensor node 1 receives a beacon signal from another sensor node, processing performed by the processor 14 moves on to S2. When a sensing result is given from the sensor 13, processing performed by the processor 14 moves on to S11. Here, it is first assumed that a sensing result of the sensor 13 is given to the processor 14.

When a sensing result of the sensor 13 is given, the data processor 22 generates data indicating the sensing result. At this time, the data processor 22 generates a time stamp in S11. The time stamp indicates a time at which data was generated (a measurement time of the sensor 13). In S12, the data processor 22 generates a data ID for identifying the data. The time stamp and the data ID are stored in transmission data, as illustrated in FIG. 4A. The time stamp and the data ID are not rewritten when the data is forwarded in the sensor network system 100.

The transmission mode selector 25 performs real-time property evaluation in S5, and performs battery residual capacity evaluation in S6. When the direct communication mode is selected in S5 or S6, processing performed by the processor 14 moves on to S8. When the direct communication mode is not selected, processing performed by the processor 14 moves on to S7.

In S7, the transmission mode selector 25 determines whether the multi-hop communication mode may be selected. When the multi-hop communication mode is selected, the processor 14 transmits the data to a sensor node 1 that has been specified in the process of S7, by using the RF transceiver 15.

When the direct communication mode is selected in S5, S6, or S7, the data is transmitted in the direct communication mode in S8. In this case, the processor 14 directly transmits the data to the data collection server 2 by using the RF transceiver 15.

After the process of S7 or S8 has been performed, the transmission power update unit 26 updates a setting value of transmission power used to transmit next beacon signal in S9. As an example, when the data is transmitted in the multi-hop communication mode, the transmission power update unit 26 reduces the setting value of transmission power. When the data is transmitted in the direct communication mode, the transmission power update unit 26 increases the setting value of transmission power.

When the sensor node 1 receives a beacon signal from another sensor node, processing performed by the processor 14 moves on to S2. In S2, the beacon response unit 24 generates a beacon response that corresponds to the received beacon signal. The beacon response is returned to a source node of the beacon signal by the RF transceiver 15. The process of S2 includes a process for determining whether a response will be made to the received beacon signal, as described later in detail. When it is determined that a response will not be made to the received beacon signal, processing performed by the processor 14 is finished.

After the processor 14 has returned the beacon response, the processor 14 waits for data. Then, the processor 14 receives the data from the source node of the beacon signal in S3. When the data is not received within a specified time period after the beacon response in S2, processing performed by the processor 14 is finished.

In S4, the transmission mode selector 25 performs data circulation evaluation. When the direct communication mode is selected in data circulation evaluation, processing performed by the processor 14 moves on to S8. When the direct communication mode is not selected, processing performed by the processor 14 moves on to S5. The processes of S5-S9 are as described above.

Processing of the flowchart illustrated in FIG. 13 is described next with reference to the example illustrated in FIGS. 6-12. Here, the operations of the sensor nodes 1a, 1b, and 1f are described.

In the sensor node 1a, a value sensed by the sensor 13 is given to the processor 14. In this case, a time stamp is generated in S11, and a data ID is generate in S12. It is assumed that the direct communication mode is not selected in S5-S7. In this case, the sensor node 1a transmits data A to the sensor node 1b in S7.

The sensor node 1b receives a beacon signal from the sensor node 1a, as illustrated in FIG. 7. Accordingly, the sensor node 1b returns a beacon response to the sensor node 1a in S2. Then, the sensor node 1b receives the data A from the sensor node 1a in S3. It is assumed that the direct communication mode is not selected in S4-S7. In this case, the sensor node 1b transmits the data A to the sensor node 1c in S7.

The sensor node 1f receives a beacon signal from the sensor node 1e, as illustrated in FIG. 11. Accordingly, the sensor node 1f returns a beacon response to the sensor node 1e in S2. Then, the sensor node 1f receives the data A from the sensor node 1e in S3. However, the direct communication mode is selected in one of S4-S7 in the sensor node 1f. In this case, the sensor node 1f directly transmits the data A to the data collection server 2, as illustrated in FIG. 12.

The procedure of the flowchart illustrated in FIG. 13 is an example, and the procedure may be changed without contradiction. As an example, the order of execution of S5 and S6 may be inverted. As another example, when real-time property evaluation is performed in S7, the process of S5 may be omitted. When a value sensed by the sensor 13 is given to the processor 14 (S1: sensing), the processes of S5 and S6 may fail to be performed.

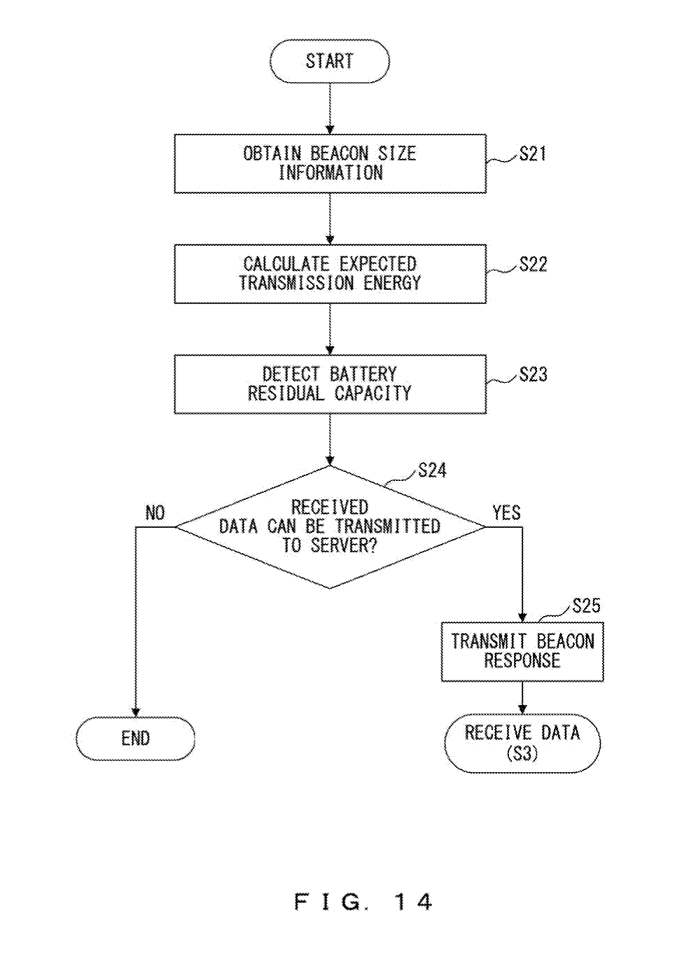

FIG. 14 is a flowchart illustrating a beacon response process. The beacon response process is performed when the sensor node 1 receives a beacon signal. The beacon response process corresponds to the process of S2 in FIG. 13.

In S21, the beacon response unit 24 obtains data size information stored in the received beacon signal. The data size information indicates the size of data that is expected to be received from a source node of the beacon signal.

In S22, the beacon response unit 24 calculates an expected transmission energy. The expected transmission energy indicates energy needed to transmit data that corresponds to the beacon signal to the data collection server 2 in the direct communication mode. The energy depends on the size of transmission data and transmission power. The size of transmission data is expressed by the data size information stored in the received beacon signal. In this example, it is assumed that a transmission power in the direct communication mode is the same for all of the sensor nodes 1, and that the transmission power has been specified in advance.

In S23, the beacon response unit 24 detects a residual capacity of the battery 11. The beacon response unit 24 determines whether a beacon response will be returned in accordance with the expected transmission energy and the residual capacity of the battery 11.

When the residual capacity of the battery 11 is sufficiently large with respect to the expected transmission energy, the beacon response unit 24 generates a beacon response in S25. The beacon response is returned to a source node of the received beacon signal by using the RF transceiver 15. When the residual capacity of the battery 11 is not sufficiently large with respect to the expected transmission energy, processing performed by the processor 14 is finished. In this case, the beacon response is not generated.

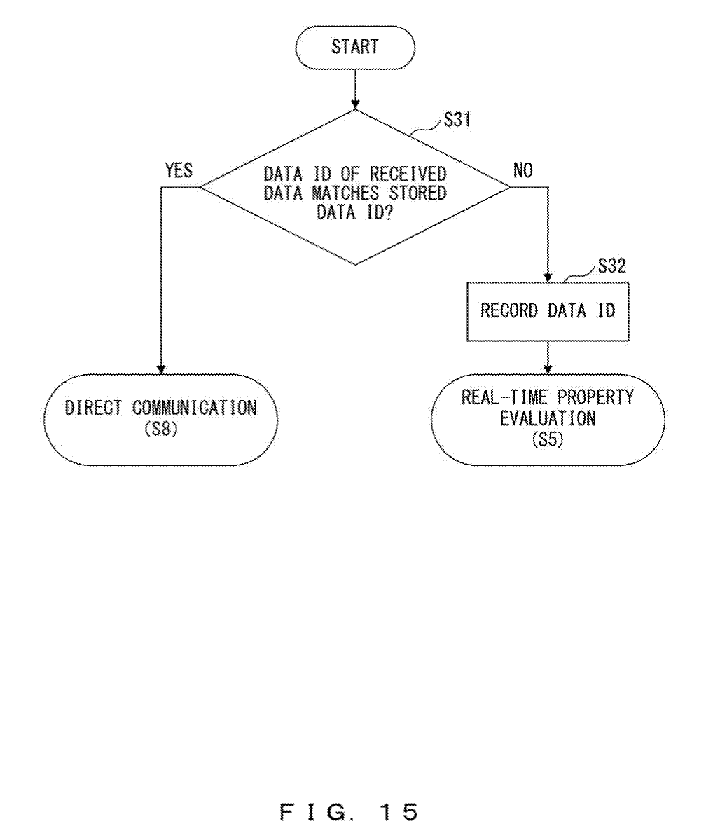

FIG. 15 is a flowchart illustrating data circulation evaluation. Data circulation evaluation corresponds to the process of S4 in FIG. 13. Namely, data circulation evaluation is performed when the sensor node 1 receives data from another sensor node.

In S31, the transmission mode selector 25 determines whether data circulation has occurred in the sensor network system 100. At this time, the transmission mode selector 25 detects a data ID of the received data. The transmission mode selector 25 determines that data circulation has occurred when the data ID of the received data matches a data ID stored in a memory of the processor 14. It is assumed that, when the processor 14 generates new data or when the processor 14 receives new data from another sensor node, the processor 14 records a data ID of the new data in a specified memory area.

When the data ID of the received data matches the data ID stored in the memory, the transmission mode selector 25 determines that data that the sensor node 1 transmitted returns to the sensor node 1 via another sensor node. Stated another way, it is determined that data circulation has occurred. Then, processing performed by the processor 14 moves on to S8 of FIG. 13. In this case, the sensor node 1 directly transmits the received data to the data collection server 2 in the direct communication mode.

When the data ID of the received data does not match the data ID stored in the memory, the transmission mode selector 25 records the data ID of the received data in the specified memory area in S32. Then, processing performed by the processor 14 moves on to S5 (real-time property evaluation) of FIG. 13. The data ID recorded in the memory may be deleted after a specified time period has passed.

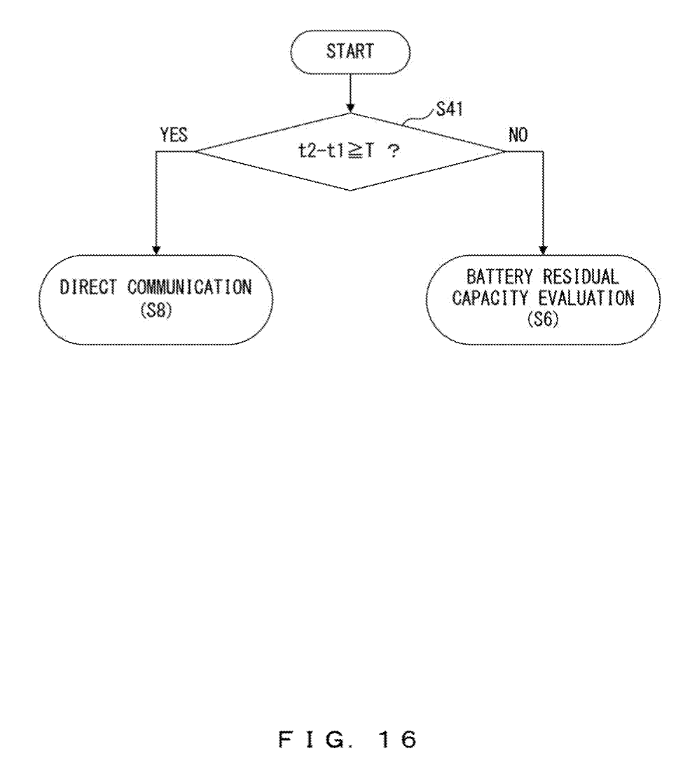

FIG. 16 is a flowchart illustrating real-time property evaluation. Real-time property evaluation corresponds to the process of S5 in FIG. 13.

In S41, the transmission mode selector 25 extracts a time stamp added to the received data. The time stamp indicates a time at which data was generated according to sensing performed by a sensor (hereinafter referred to as a data generation time). The transmission mode selector 25 determines whether a time period that has passed after the data generation time is greater than or equal to a specified threshold time. It is assumed that the data generation time is t1, a current time is t2, and a specified threshold time is T. It is determined whether “t2−t1≧T” is satisfied.

When a time period that has passed after the data generation time is greater than or equal to the threshold time, processing performed by the processor 14 moves on to S8 of FIG. 13. In this case, the sensor node 1 directly transmits the received data to the data collection server 2 in the direct communication mode. Consequently, the data collection server 2 can receive the data that was generated in the sensor node 1 without delay. When a time period that has passed after the data generation time is smaller than the threshold time, processing performed by the processor 14 moves on to S6 (battery residual capacity evaluation) of FIG. 13.

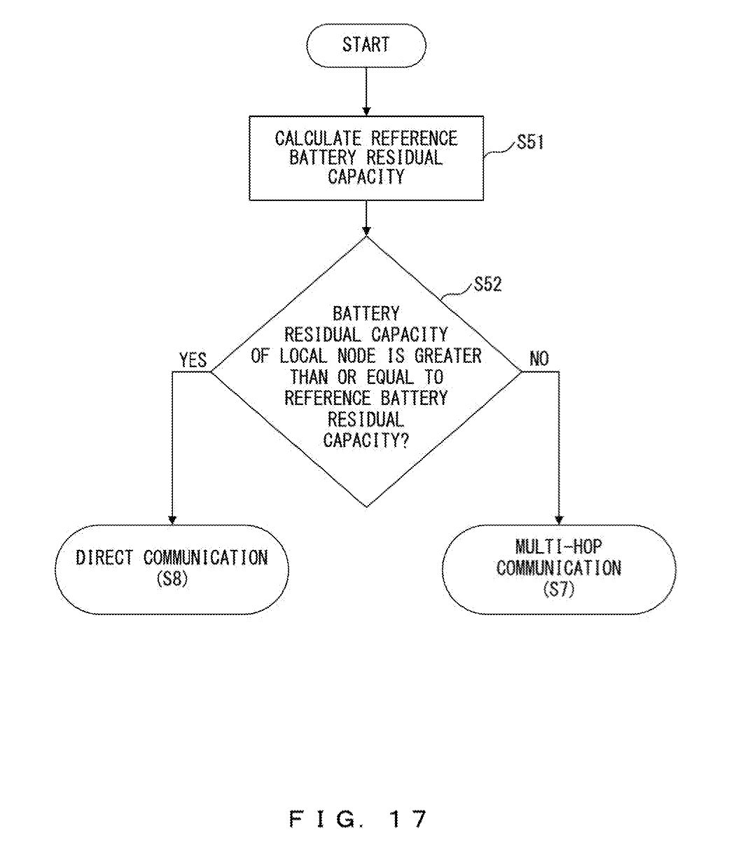

FIG. 17 is a flowchart illustrating battery residual capacity evaluation. Battery residual capacity evaluation corresponds to S6 of FIG. 13.

In S51, the transmission mode selector 25 calculates a reference battery residual capacity in accordance with an average battery residual capacity and a standard deviation reported by the received data. The reference battery residual capacity is calculated, for example, according to Cₐᵥₑ+2C_{dev}. Cₐᵥₑ indicates the reported average battery residual capacity. C_{dev} indicates the reported standard deviation.

The reference battery residual capacity may be calculated by using another method. As an example, the reference battery residual capacity may be a sum of the average battery residual capacity and the standard deviation. Alternatively, the reference battery residual capacity may be calculated without using the standard deviation. As an example, the reference battery residual capacity may be calculated by K*Cₐᵥₑ (K>1)”.

In S52, the transmission mode selector 25 compares the residual capacity of the battery 11 (namely, a local node battery residual capacity) with the reference battery residual capacity. When the local node battery residual capacity is greater than or equal to the reference battery residual capacity, the transmission mode selector 25 determines that the residual capacity of the battery 11 of the sensor node itself is greater than the residual capacities of batteries of peripheral nodes. Then, processing performed by the processor 14 moves on to S8 of FIG. 13. In this case, the sensor node 1 directly transmits the received data to the data collection server 2 in the direct communication mode. When the local node battery residual capacity is smaller than the reference battery residual capacity, processing performed by the processor 14 moves on to S7 (a multi-hop communication process) of FIG. 13.

As described above, in battery residual capacity evaluation, the direct communication mode that has a large power consumption is selected with priority in a sensor node 1 that has a larger battery residual capacity than those of peripheral nodes. Consequently, variation in a battery residual capacity is suppressed in a plurality of sensor nodes of the sensor network system 100.

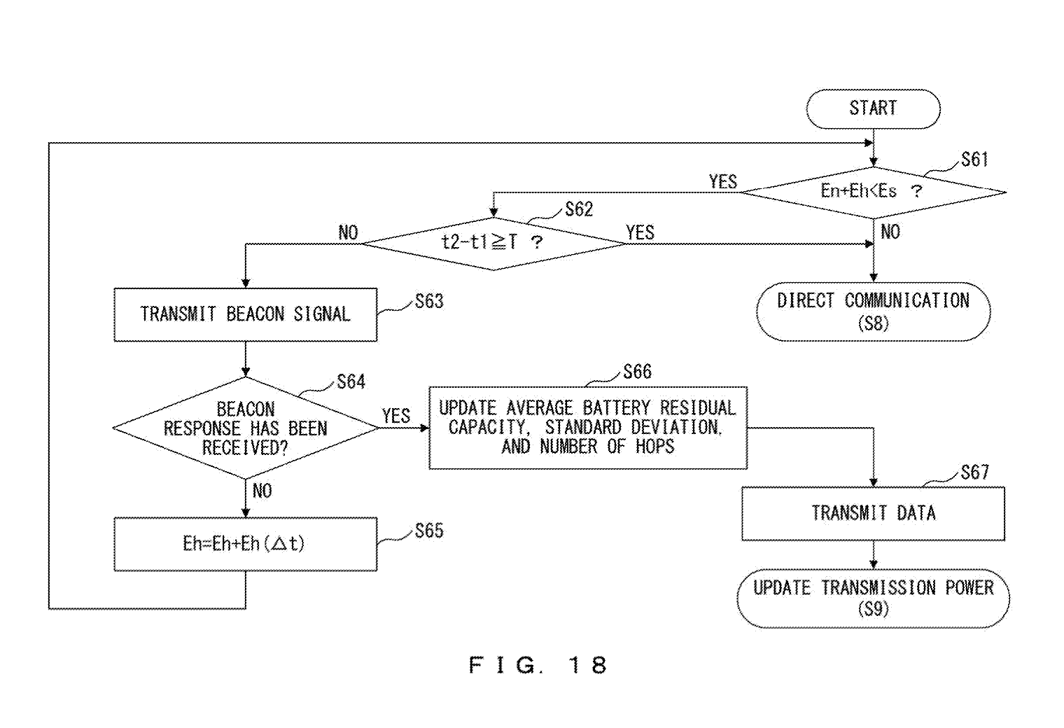

FIG. 18 is a flowchart illustrating the multi-hop communication process. The multi-hop communication process corresponds to S7 of FIG. 13.

In S61, the transmission mode selector 25 performs energy consumption evaluation. In energy consumption evaluation, the transmission mode selector 25 compares the sum of “energy to transmit data to an adjacent node (an inter-node communication energy En)” and “energy to store data in a sensor node 1 (a data storing energy Eh)” with “energy to directly transmit data to the data collection server 2 (a direct communication energy Es)”.

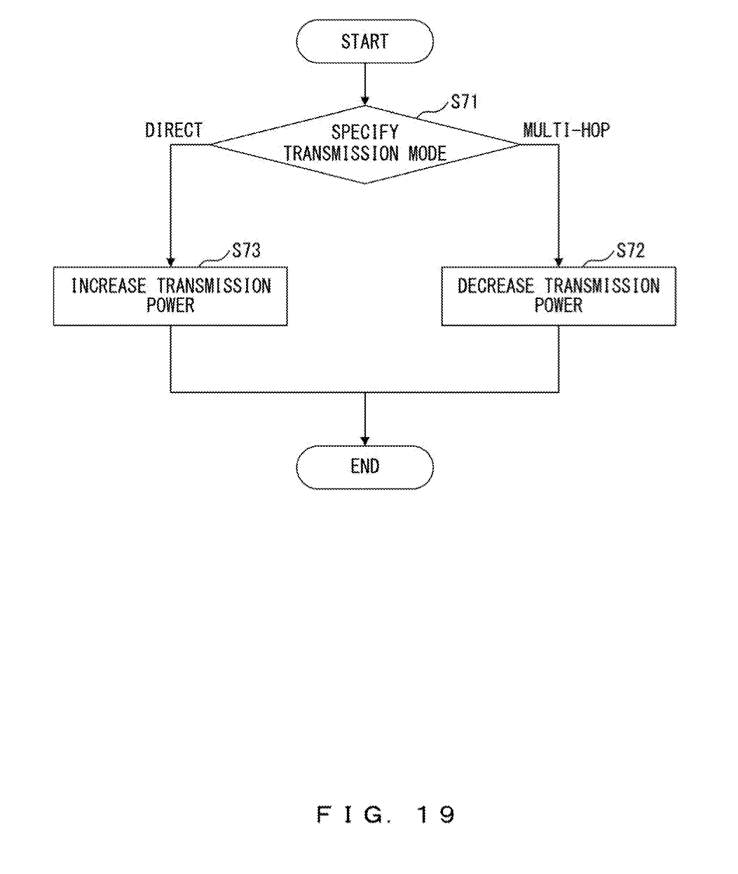

The inter-node communication energy En is calculated according to the size of transmission data and a transmission power that is determined as a result of an updating process illustrated in FIG. 19. The data storing energy Eh is calculated in S65. The direct communication energy Es is calculated according to the size of transmission data and a transmission power in the direct communication mode. It is assumed in this example that the transmission power in the direct communication mode is the same in all of the sensor nodes 1, and that the transmission power is specified in advance.

When the sum of the inter-node communication energy En and the data storing energy Eh is greater than or equal to the direct communication energy Es (S61: No), it is determined that an energy consumption in the direct communication mode is smaller than that in the multi-hop communication mode. In this case, processing performed by the processor 14 moves on to S8 of FIG. 13. Then, the sensor node 1 directly transmits the received data to the data collection server 2 in the direct communication mode. When the sum of the inter-node communication energy En and the data storing energy Eh is smaller than the direct communication energy Es, processing performed by the processor 14 moves on to S62.

The process of S62 is substantially the same as the processing of real-time property evaluation illustrated in FIG. 16. Namely, when a time period that has passed after the data generation time is greater than or equal to a threshold time, processing performed by the processor 14 moves on to S8 of FIG. 13. In this case, the sensor node 1 directly transmits the received data to the data collection server 2 in the direct communication mode. When a time period that has passed after the data generation time is smaller than the threshold time, processing performed by the processor 14 moves on to S63.

In S63 and S64, the beacon generator 23 generates a beacon signal. An example of the beacon signal has been described with reference to FIG. 4B. The beacon generator 23 transmits the generated beacon signal by using the RF transceiver 15. A transmission power of the beacon signal is determined as a result of the updating process illustrated in FIG. 19. Then, the transmission mode selector 25 waits for a beacon response that corresponds to the beacon signal during a specified time period.

The beacon signal transmitted in S63 is received by a sensor node 1 that is located within a beacon range. The sensor node 1 that receives the beacon signal performs the beacon response process illustrated in FIG. 14. Stated another way, from among the sensor nodes 1 that have received the beacon signal, a sensor node 1 that can transmit data to the data collection server 2 returns a beacon response.

When a beacon response is returned within a specified time period (S64: Yes), the transmission mode selector 25 selects the multi-hop communication mode. In this case, in S66, the data processor 22 updates the average battery residual capacity, the standard deviation, and the number of hops that are illustrated in FIG. 4A. At this time, a new average battery residual capacity is calculated according to the average battery residual capacity and the number of hops that are recorded in the received data and a local node battery residual capacity. In addition, a new standard deviation is calculated according to the average battery residual capacity, the standard deviation, and the number of hops that are recorded in the received data and the local node battery residual capacity. Further, the number of hops is incremented by 1.

In S67, the processor 14 transmits the data by using the RF transceiver 15. The destination of the data is a transmission source node of the beacon response. Namely, multi-hop forwarding is performed. At this time, the RF transceiver 15 transmits the data at a transmission power determined as a result of the updating process illustrated in FIG. 19.

When a beacon response is not returned within a specified time period (S64: No), the transmission mode selector 25 updates the data storing energy Eh in S65. The data storing energy Eh is updated according to the following expression.

Eh=Eh+Eh(Δt)

An initial value of Eh is zero. Eh(Δt) is a function that is proportional to the size of data stored in a memory. Δt indicates a time period that has passed after the data obtaining unit 21 obtained data. Namely, when a value sensed by the sensor 13 is given to the processor 14, Δt indicates a time period that has passed after the value was given to the processor 14. When the sensor node 1 receives data from another sensor node, Δt indicates a time period that has passed after a data reception time. In this example, it is assumed that the data storing energy Eh increases in proportion to a time period that has passed since the data obtaining unit 21 obtained data.

The processes of S61-S65 are repeatedly performed until the processor 14 receives a beacon response. During a period in which the processes of S61-S65 are repeatedly performed, the data storing energy Eh gradually increases as a result of the process of S65. When the sum of the inter-node communication energy En and the data storing energy Eh increases to the direct communication energy Es, the decision result in S61 becomes “No”. In this case, the direct communication mode is selected by the transmission mode selector 25. Similarly, when a time period that has passed after the data generation time reaches a threshold time during a period in which the processes of S61-S65 are repeatedly performed, the decision result in S62 becomes “Yes”. Also in this case, the direct communication mode is selected by the transmission mode selector 25.

As described above, in the multi-hop communication process, data is transmitted to a source node of a beacon response. When the processor 14 does not receive a beacon response, the direct communication mode is selected, and the data is directly transmitted to the data collection server 2.

FIG. 19 is a flowchart illustrating a transmission power updating process. The transmission power updating process corresponds to the process of S9 in FIG. 13.

In the transmission power updating process, a transmission power in multi-hop communication is updated. In this example, a transmission power for transmitting the beacon signal above is the same as the transmission power in multi-hop communication. Stated another way, a beacon range depends on the transmission power in multi-hop communication.

When the beacon range is wide, it is expected that the number of sensor nodes 1 that are located within the beacon range increases. Namely, when the beacon range is wide, a probability of beacon communication using a beacon signal and a beacon response being successful increases. Accordingly, in order to increase the probability of beacon communication being successful, it is preferable that the transmission power in multi-hop communication be high. However, when the transmission power in multi-hop communication is high, an energy consumption of the sensor node 1 is large, and the life of the sensor node 1 is likely to become shorter. Accordingly, it is preferable that the transmission power in multi-hop communication be reduced as much as possible in a state in which a high probability of beacon communication being successful is maintained.

In a sensor network system in which respective sensor nodes 1 are movable, distances between nodes are not constant, and therefore it is difficult to determine in advance a preferable transmission power in multi-hop communication. The preferable transmission power in multi-hop communication depends on the number (or the density) of sensor nodes that are installed in a sensing target field, an application executed in the sensor network system, and the like. Accordingly, in the sensor network system 100, the transmission power in multi-hop communication is dynamically determined for each of the sensor nodes 1.

In S71, the transmission power update unit 26 specifies a performed transmission mode. When data was transmitted in the multi-hop communication mode, it is decided that beacon communication is successful. In this case, it is considered that the beacon range is sufficiently wide. Accordingly, in S72, the transmission power update unit 26 issues an instruction to the RF transceiver 15 in such a way that a transmission power for transmitting the next beacon signal decreases by a specified amount.

When data was transmitted in the direct communication mode, it is decided that beacon communication may be unsuccessful. In this case, it is considered that the beacon range may be excessively small. Accordingly, in S73, the transmission power update unit 26 issues an instruction to the RF transceiver 15 in such a way that a transmission power for transmitting the next beacon signal increases by a specified amount.

As described above, in the sensor network system 100 in which respective sensor nodes 1 are movable, there may be no other sensor nodes that exist near a sensor node 1 that has obtained data. Namely, multi-hop communication may fail depending on locations of the sensor nodes. Therefore, the sensor node 1 that has obtained data selects a preferable transmission mode according to energy consumption evaluation, real-time property evaluation, battery residual capacity evaluation, and data circulation evaluation. In an example, data is transmitted in the multi-hop communication mode, only when the multi-hop communication mode was selected in all of the evaluations above. When the direct communication mode is selected in at least one of the evaluations, data is transmitted to the data collection server 2 in the direct communication mode. Consequently, energy consumption is suppressed in respective sensor nodes, energy consumption is reduced in the entirety of the sensor network system, and variation in a battery residual capacity of a plurality of sensor nodes is suppressed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A sensor network system comprising:
a plurality of sensor nodes; and
a server configured to collect data from the plurality of sensor nodes, wherein
when a first sensor node among the plurality of sensor nodes obtains data, the first sensor node selects a first transmission mode to directly transmit the data to the server or a second transmission mode to transmit the data to another sensor node among the plurality of sensor nodes based on a first energy to directly transmit the data to the server, a second energy to transmit the data to the other sensor node, and a third energy to store the data in the first sensor node, and
the first sensor node transmits the data to the server or the other sensor node in the selected transmission mode.

2. The sensor network system according to claim 1, wherein
when a sum of the second energy and the third energy is smaller than the first energy, the first sensor node transmits the data to the other sensor node in the second transmission mode, and
when the sum of the second energy and the third energy is greater than or equal to the first energy, the first sensor node transmits the data to the server in the first transmission mode.

3. The sensor network system according to claim 1, wherein
the second energy is proportional to a transmission power that is updated according to the transmission mode selected by the first sensor node.

4. The sensor network system according to claim 1, wherein
the third energy is proportional to a time period that has passed after the first sensor node obtained the data.

5. The sensor network system according to claim 1 wherein
when a time period that has passed after the data was generated exceeds a specified threshold time, the first sensor node transmits the data to the server in the first transmission mode.

6. The sensor network system according to claim 1, wherein
when the data transmitted from the first sensor node returns to the first sensor node via one or more of the plurality of sensor nodes, the first sensor node transmits the data to the server in the first transmission mode.

7. The sensor network system according to claim 1, wherein
a battery residual capacity of the first sensor node is greater than or equal to a reference battery residual capacity that is calculated according to an average battery residual capacity of respective sensor nodes on a route from a sensor node that generated the data to the first sensor node, the first sensor node transmits the data to the server in the first transmission mode.

8. The sensor network system according to claim 1, wherein
a battery residual capacity of the first sensor node is greater than or equal to a reference battery residual capacity that is calculated according to an average and a standard deviation of battery residual capacity of respective sensor nodes on a route from a sensor node that generated the data to the first sensor node, the first sensor node transmits the data to the server in the first transmission mode.

9. The sensor network system according to claim 1, wherein
the first sensor node transmits a beacon signal when the first sensor node obtains the data,
when a second sensor node that receives the beacon signal determines that the second sensor node is able to directly transmit the data to the server, the second sensor node transmits a beacon response that corresponds to the beacon signal to the first sensor node, and
when the first sensor node receives the beacon response from the second sensor node, and when a sum of the second energy and the third energy is smaller than the first energy, the first sensor node transmits the data to the second sensor node in the second transmission mode.

10. The sensor network system according to claim 9, wherein
when the first sensor node transmits data to the server in the first transmission mode, the first sensor node increases a transmission power to transmit a next beacon signal.

11. The sensor network system according to claim 9, wherein
when the first sensor node transmits data in the second transmission mode, the first sensor node decreases a transmission power to transmit a next beacon signal.

12. A data transmission method used in a sensor network system that includes a plurality of sensor nodes and a server configured to collect data from the plurality of sensor nodes, the data transmission method comprising:
selecting a first transmission mode to directly transmit data from a first sensor node among the plurality of sensor nodes to the server or a second transmission mode to transmit the data from the first sensor node to a second sensor node among the plurality of sensor nodes based on a first energy to directly transmit the data from the first sensor node to the server, a second energy to transmit the data from the first sensor node to the second sensor node, and a third energy to store the data in the first sensor node, and
transmitting the data from the first sensor node to the server or the second sensor node in the selected transmission mode.

13. A sensor node used in a sensor network system that includes a plurality of sensor nodes and a server configured to collect data from the plurality of sensor nodes, the sensor node comprising:
a sensor;
a radio transceiver; and
a processor configured to:
obtain data from the sensor or another sensor node among the plurality of sensor nodes; and
select a first transmission mode to directly transmit the data to the server or a second transmission mode to transmit the data to a second sensor node among the plurality of sensor nodes based on a first energy to directly transmit the data to the server, a second energy to transmit the data to the second sensor node, and a third energy to store the data, wherein
the radio transceiver transmits the data to the server or the second sensor node in the transmission mode selected by the processor.
